(19) United States
(12) Patent Application Publication
(10) Pub. No.: US 2023/0328580 A1
(43) Pub. Date: Oct. 12, 2023

(54) QOS PROFILE ADAPTATION

(71) Applicant: Lenovo (Singapore) Pte. Ltd., New Tech Park (SG)

(72) Inventors: Emmanouil Pateromichelakis, Viersen (DE); Ravi Kuchibhotla, Chicago, IL (US)

(21) Appl. No.: 18/024,482

(22) PCT Filed: Sep. 2, 2020
(86) PCT No.: PCT/EP2020/074495

§ 371 Date: Mar. 2, 2023

(51) Int. Cl. H04W 28/02; H04W 28/12

(52) U.S. Cl. CPC H04W 28/0268; H04W 28/12

(57) ABSTRACT

Apparatuses, methods, and systems are disclosed for configuring a predictive QoS adaptation pattern. One apparatus (600) includes an interface (640) that receives (705) a QoS parameter for at least one QoS flow, the at least QoS flow corresponding to at least one UE. The apparatus (600) includes a processor (605) that obtains (710) a data analytics model and (determines 715) an expected QoS profile adaptation pattern comprising at least one QoS profile to be associated with the at least one QoS flow during a first time interval. Here, the data analytics model described at least one expected condition for the at least one UE and/or at least one serving RAN node. Via the interface (640), the processor (605) transmits (720) the expected QoS profile adaptation pattern to at least one network node associated with the QoS flow.

### FIELD

The subject matter disclosed herein relates generally to wireless communications and more particularly relates to adapting the QoS profiles of one or more QoS flows in a mobile communication system.

### BACKGROUND

The following abbreviations are herewith defined, at least some of which are referred to within the following description: Third Generation Partnership Project (“3GPP”), Fifth Generation Core Network (“5CG”), Fifth Generation System (“5GS”), Fifth Generation QoS Identifiers (“5QI”), Authentication, Authorization and Accounting (“AAA”), Access and Mobility Management Function (“AMF”), Positive-Acknowledgment (“ACK”), Application Function (“AF”), Artificial Intelligence (“AI”), Application Programming Interface (“API”), Access Stratum (“AS”), Base Station (“BS”), Control Element (“CE”), Core Network (“CN”), Channel Quality Indicator (“CQI”), Downlink (“DL”), Data Radio Bearer (“DRB”), Discontinuous Transmission (“DTX”), Enhanced Inter-cell Interference Coordination (“eICIC”), Evolved Node-B (“eNB”), Evolved Packet Core (“EPC”), Evolved Packet System (“EPS”), Evolved UMTS Terrestrial Radio Access (“E-UTRA”), Evolved UMTS Terrestrial Radio Access Network (“E-UTRAN”), European Telecommunications Standards Institute (“ETSI”), Guaranteed Bit Rate (“GBR”), New Generation (i.e., 5G) Node-B (“gNB”), General Packet Radio Service (“GPRS”), Generic Public Service Identifier (“GPSI”), Global System for Mobile Communications (“GSM”), Hybrid Automatic Repeat Request (“HARQ”), Home Subscriber Server (“HSS”), Inter-cell Interference Coordination (“ICIC”), Information Element (“IE”), Industrial IoT (“IIOT”), Internet of Things (“IoT”), Key Performance Indicator (“KPI”), Long Term Evolution (“LTE”), Machine Learning (“ML”), Mobility Management (“MM”), Mobility Management Entity (“MME”), Negative-Acknowledgment (“NACK”) or (“NAK”), Non-Access Stratum (“NAS”), New Generation Radio Access Network (“NG-RAN”, a RAN used for 5GS networks), Neural Network (“NN”), Network Slice Selection Assistance Information (“NSSAI”, e.g., a vector value including one or more S-NSSAI values), New Radio (“NR”, a 5G radio access technology; also referred to as “5G NR”), Packet Data Unit (“PDU”, used in connection with ‘PDU Session’), Public Land Mobile Network (“PLMN”), Precoding Matrix Indicator (“PMI”), Predictive QoS (“P-QoS”), QoS Flow Indicator (“QFI”), Quality of Experience (“QoE”), Quality of Service (“QoS”), Radio Access Network (“RAN”), Rank Indicator (“RI”), RAN Intelligent Controller (“RIC”), Radio Link Monitoring (“RLM”), Radio Network Information (“RNI”), RNI Service (“RNIS”), Radio Resource Management (“RRM”), Receive (“RX”), Signal-to-Interference-and-Noise Ratio (“SINR”), Session Management (“SM”), Session Management Function (“SMF”), Single Network Slice Selection Assistance Information (“S-NSSAI”), Service Provider (“SP”), Support Vector Machine (“SVM”), Transport Block (“TB”), Transmit (“TX”), Unified Data Management (“UDM”), User Data Repository (“UDR”), User Entity/Equipment (Mobile Terminal) (“UE”), Uplink (“UL”), User Plane (“UP”), Universal Mobile Telecommunications System (“UMTS”), UMTS Terrestrial Radio Access (“UTRA”), UMTS Terrestrial Radio Access Network (“UTRAN”), and Worldwide Interoperability for Microwave Access (“WiMAX”). As used herein, “HARQ-ACK” may represent collectively the Positive Acknowledge (“ACK”) and the Negative Acknowledge (“NACK”) and Discontinuous Transmission (“DTX”). ACK means that a TB is correctly received while NACK (or NAK) means a TB is erroneously received. DTX means that no TB was detected.

In communication networks, Quality of service (“QoS”) is the description or measurement of the overall performance of a service. To quantitatively measure quality of service, several related aspects of the network service are often considered, such as packet loss, bit rate, throughput, transmission delay, availability, jitter, etc. In wireless communication systems, QoS may refer to traffic prioritization and resource reservation control mechanisms, rather than the achieved service quality. Quality of service is the ability to provide different priorities to different applications, users, or data flows, or to guarantee a certain level of performance to a data flow.

### BRIEF SUMMARY

Methods for configuring a predictive QoS adaptation pattern are disclosed. Apparatuses and systems also perform the functions of the methods.

One method of an intelligent control unit includes receiving a QoS parameter for at least one QoS flow, the at least QoS flow corresponding to at least one UE. The method includes obtaining a data analytics model, the data analytics model describing at least one expected condition for the at least one UE and/or at least one serving RAN node. The method includes determining an expected QoS profile adaptation pattern based on the data analytics model for a first time interval, wherein the expected QoS profile adaptation pattern comprises at least one QoS profile to be associated with the at least one QoS flow during the first time interval. The method includes transmitting the expected QoS profile adaptation pattern to at least one network node associated with the QoS flow.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a wireless communication system for configuring a predictive QoS adaptation pattern;

FIG. 1B is a schematic block diagram illustrating one embodiment of an O-RAN deployment for configuring a predictive QoS adaptation pattern;

FIG. 2 is a diagram illustrating one embodiment of configuring a predictive QoS adaptation pattern;

FIG. 3 is a diagram illustrating signaling flow for one embodiment of a 5GS implemented procedure for AI-assisted QoS profile pattern prediction and adaptation;

FIG. 4 is a diagram illustrating signaling flow for one embodiment of an O-RAN implemented procedure for AI-assisted QoS profile pattern prediction and adaptation;

FIG. 5 is a diagram illustrating one embodiment of a user equipment apparatus that may be used for configuring a predictive QoS adaptation pattern;

FIG. 6 is a diagram illustrating one embodiment of a network equipment apparatus that may be used for configuring a predictive QoS adaptation pattern; and

FIG. 7 is a flowchart diagram illustrating one embodiment of a method that may be used for configuring a predictive QoS adaptation pattern.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for AI-assisted QoS profile pattern prediction and adaptation. The high-level problem to be solved by this disclosure is how to configure a predictive/prescriptive QoS profile adaptation for a QoS flow, considering traffic and mobility data analytics.

For some verticals (Smart Factories, V2X), the prediction of a QoS downgrade at the network side and the pro-active application adaptation to ensure service continuity is of key importance (especially for URLLC type of traffic).

For V2X, HOT scenarios, there may be requirements regarding prediction (e.g., for predictive maintenance, for pro-active application adaptation), with application layer impacts.

In some embodiments, such as for V2X, there may be requirements to support predicted QoS to the 3rd party are specified. In this, it may be assumed that a 3GPP network informs the AF about the expected QoS downgrade, e.g., based on network data analytics at NWDAF to the V2X Application; however, it may be required that the V2X application will provide the necessary data to allow for QoS analytics. Some example use cases include applications such as condition monitoring and predictive maintenance based on sensor data, but also big data analytics for optimizing future parameter sets of a certain process.

One further use case, which may require the prediction of the QoS, is the eHealth vertical industry. In particular, the transfer of a patient with the ambulance to the hospital will have a predicted route, and one key requirement (if 5G eHealth services are provided e.g. for remote surgery, video feed for remote monitoring) will be to ensure meeting the end to end SLA with minimum fluctuations of performance. In this scenario, by predicting the QoS possible upgrades/downgrades based on channel statistics along the route, the access network will be able to pre-allocate network and radio resources for the expected route (which may involve multiple BSs/gNBs or even multiple networks).

In various embodiment, an Alternative QoS profile feature may be used. A QoS flow is the most granular measure of QoS in the 5G network and the level at which QoS is enforced, whereas a QoS profile is the set of QoS attributes (or the QoS class, aka 5QI in 5GS) which can be mapped to the QoS flow at the network side. In particular, the AF (service provider/vertical) may provide at the SLA, multiple application QoS levels for one requested session. The 5G Network maps the session with the original and the lower priority Alternative QoS profiles (original 5QI X>Alternative 1 5QI Y>Alternative 2 5QI Z). The RAN gets informed by CN about the Alternative QoS profiles which can be mapped to a QoS flow. The RAN checks whether the originally-set QoS attributes can be fulfilled. If not, RAN requests CN to perform QoS downgrade to one of the Alternative QoS profiles

When an Alternative QoS profile is used, RAN checks continuously whether the higher priority Alternatives or the original QoS profile can be fulfilled again, to perform a QoS upgrade (which is defined as the upgrade to a different alternative or to the originally selected QoS profile. The RAN needs to check regularly on the fulfilment/unfulfillment of a QoS profile for many QoS flows. So, it may need to do the following for multiple flows (based on subscription or request by the upper layers). It needs to decide whether to perform 1) QoS Upgrade, 2) QoS Downgrade, 3) Stay as is. The RAN also needs to decide to which QoS profile to Upgrade or Downgrade.

This poses additional complexity and/or processing burden at RAN nodes, which grows significantly as the number of QoS flows and the QoS alternatives increase. Furthermore, the decision on the QoS profile change is taken at the SMF; hence considering the signaling requirement for multiple flows and frequent transitions, the real benefit may be marginal.

In some embodiments, Quality of Experience (“QoE”) is a metric related to QoS; however, QoE may indicate more information relating to an impact at the application side (e.g., it may be interpreted in more generic way of application QoS requirements). In one embodiment, the QoE may be determined as described in ITU-T P.1203.3. In various embodiments, QoE is calculated at application layer and usually refers to video related QoE score/MOS score (video MOS or customized), initial buffering, Stalling events, Stall ratio. The QoE target may be pre-defined; however, in similar manner as QoS, different targets may be negotiated at the SLA agreement between MNO and Vertical/customer. The QoE monitoring and upgrade/downgrade decision may not be provided at RAN (currently is not supported); however, the mapping of QoE to QoS profile may be provided by upper layers (core network, application function).

In some embodiments, it may not be known how RAN will check for a possible QoS downgrade so as to adapt the QoS offering to ensure service continuity (to avoid violating minimum agreed QoS). Further, it may not be known how RAN will check for a possible QoS upgrade to provide the optimal QoS offering (ensuring maximum agreed QoS).

In various embodiments, the per user QoS/QoE may be proactively optimized in RAN with techniques directed to one or more of the following: 1) How to pro-actively/dynamically capture a QoS downgrade at RAN (QoS flow re-mapping to a lower priority QoS profile, to ensure meeting the per UE QoE targets); and/or 2) How to pro-actively/dynamically capture a QoS upgrade at RAN (QoS flow re-mapping to a higher priority QoS profile, to optimize the user and RAN performance?

In some embodiments, for a given GBR QoS Flow, Notification control is enabled and the NG-RAN has received a list of Alternative QoS Profile(s) for this QoS Flow and supports the Alternative QoS Profile handling, the following may apply:
A) If the NG-RAN determines that the GFBR, the PDB or the PER of the QoS profile cannot be fulfilled, NG-RAN shall send a notification towards SMF that the “GFBR can no longer be guaranteed”. Before sending a notification that the “GFBR can no longer be guaranteed” towards the SMF, the NG-RAN shall check whether the GFBR, the PDB and the PER that the NG-RAN currently fulfils match any of the Alternative QoS Profile(s) in the indicated priority order. If there is a match, the NG-RAN shall indicate the reference to the matching Alternative QoS Profile.
B) The NG-RAN should always try to fulfil the QoS profile and any Alternative QoS Profile that has higher priority than the currently fulfilled situation. In order to avoid a too frequent signaling to the SMF, it is assumed that NG-RAN implementation can apply hysteresis (e.g., via a configurable time interval).

This problem of checking for QoS unfulfillment at RAN is not solved in current 3GPP specifications. To support adaptive QoE management schemes that enable network intelligent optimization to satisfy user experience for diverse services, a network may use AI/ML to provide support for RAN function optimization. Such adaptive QoE management schemes may also apply where base station disaggregation in central and distributed units (as well as in control and user plane) is supported.

Additionally, an ETSI MEC allows the exposure of APIs from RAN to MEC platforms. The exposure of APIs from network to the edge service provider may relate to the UE location information, Bandwidth management, Radio Network Information (RNI). ETSI GS MEC 012 specifies the RNI API exposure from RAN to MEC. More specifically, Radio Network Information Service (RNIS) is a service that provides radio network related information to MEC applications and to MEC platforms. The granularity of the radio network information may be adjusted based on parameters such as information per cell, per User Equipment, per QoS class or it may be requested over period of time. The Radio Network Information may be used by the MEC applications and MEC platform to optimize the existing services and to provide new type of services that are based on up to date information on radio conditions.

Further, the O-RAN alliance which investigates the virtualization of access domain and considers the virtualization of control functionalities (i.e., RRC/RRM) to a newly defined RAN Intelligent Controller (“RIC”) which may co-located with the gNB or can be deployed for a cluster of gNBs. In this context, given the deployment and the functional requirements (real-time, non-real time, near real-time) as well as the slice isolation policies, the RRM/RRC functionalities can be either flexibly located either at the centralized/distributed unit or to dedicated RICs, e.g., near-RT RIC and non-RT RIC.

To solve the above discussed problems with QoS adaptation, the present disclosure uses AI/ML models to extend the QoS prediction and multi-QoS profile features by configuring a pattern of predicted QoS profiles for the QoS flow, based on an AI function.

Disclosed herein are techniques for providing AI-assisted QoS-flow-to-QoS-adaptation-pattern mapping (e.g., at an AI-enabled RAN control entity). The type of analytics which assist the configuration (re)mapping, may be either Predictive Analytics (i.e., denoting what is going to happen with respect to QoS fluctuations) or Prescriptive Analytics (i.e., denoting what action is needed to be taken as recommendation or enforcement, e.g., sequence of QoS upgrade/downgrade indications).

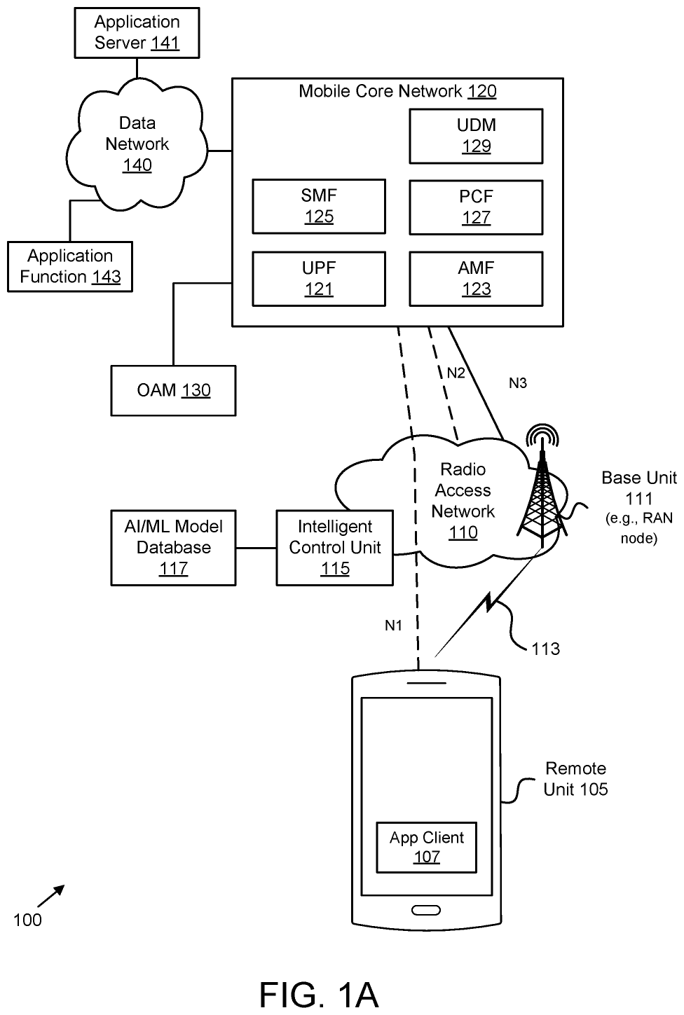

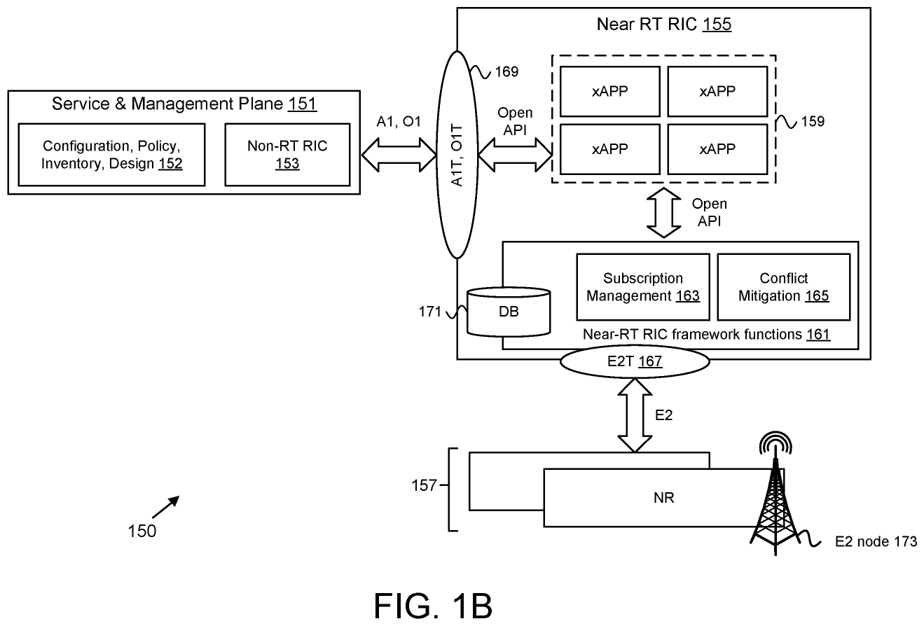

FIG. 1A depicts a wireless communication system 100 for configuring a predictive QoS adaptation pattern, according to embodiments of the disclosure. In one embodiment, the wireless communication system 100 includes at least one remote unit 105, at least one access network 110, and a mobile core network 120. The access network(s) 110 and the mobile core network 120 form a mobile communication network. Even though a specific number of remote unit 105, access networks 110, and mobile core networks 120 are depicted in FIG. 1A, one of skill in the art will recognize that any number of remote units 105, access networks 110, and mobile core networks 120 may be included in the wireless communication system 100.

Each access networks 110 contains at least one base unit 111 and may be composed of a 3GPP access network (containing at least one cellular base unit) and/or a non-3GPP access network (containing at least one access point). In various embodiments, an access network 110 is a radio access network, such as a 5G-RAN. A remote unit 105 may communicate with a 3GPP access network using 3GPP communication links and/or may communicate with a non-3GPP access network using non-3GPP communication links.

In one implementation, the wireless communication system 100 is compliant with the 5G system specified in the 3GPP specifications. More generally, however, the wireless communication system 100 may implement some other open or proprietary communication network, for example, LTE or WiMAX, among other networks. The present disclosure is not intended to be limited to the implementation of any particular wireless communication system architecture or protocol.

In one embodiment, a remote unit 105 may include computing devices, such as desktop computers, laptop computers, personal digital assistants (“PDAs”), tablet computers, smart phones, smart appliances (e.g., appliances connected to the Internet), game consoles, remote controllers, or the like. Moreover, the remote unit 105 may be referred to as a UE, a subscriber unit, a mobile, a mobile station, a terminal, a mobile terminal, a fixed terminal, a subscriber station, a user terminal, a wireless transmit/receive unit (“WTRU”), a device, or by other terminology used in the art.

The remote unit(s) 105 may communicate directly with one or more of the base units 111 in the access network 110 via uplink (“UL”) and downlink (“DL”) communication signals. In some embodiments, the UL and DL communication signals are carried over the 3GPP communication links. In other embodiments, the UL and DL communication signals are carried over the non-3GPP communication links. Here, the access network 110 is an intermediate network that provides the remote unit 105 with access to the mobile core network 120.

As described in further detail below, the remote unit 105 may establish a PDU session (or similar data connection) with the mobile core network 120 via the access network 110. The mobile core network 120 then relays traffic between the remote unit 105 and the data network 140 using the PDU session. Note that the remote unit 105 may establish one or more PDU sessions (or other data connections) with the mobile core network 120. As such, the remote unit 105 may have at least one PDU session for communicating with the application server 141. The remote unit 105 may establish additional PDU sessions for communicating with other data network and/or other remote hosts.

In some embodiments, the remote units 105 communicate with an application server 141 (or other communication peer) via a network connection with the mobile core network 120. For example, an application client 107 in a remote unit 105 (e.g., web browser, media client, telephone/VoIP application) may trigger the remote unit 105 to establish a PDU session (or other data connection) with the mobile core network 120 and access network 110. In order to establish the PDU session, the remote unit 105 must be registered with the mobile core network.

The base units 111 may be distributed over a geographic region. In certain embodiments, a base unit 111 may also be referred to as an access point, an access terminal, a base, a base station, a Node-B, an eNB, a gNB, a Home Node-B, a relay node, a RAN node, an E2 node, or by any other terminology used in the art. The base units 111 are generally part of a radio access network (“RAN”), such as access network 110, that may include one or more controllers communicably coupled to one or more corresponding base units 111. These and other elements of radio access network are not illustrated but are well known generally by those having ordinary skill in the art. The base units 111 connect to the mobile core network 120 via the access network 110.

The base units 111 may serve a number of remote units 105 within a serving area, for example, a cell or a cell sector, via a wireless communication link. The base units 111 may communicate directly with one or more of the remote units 105 via communication links 113. Generally, the base units 111 transmit DL communication signals to serve the remote units 105 in the time, frequency, and/or spatial domain, and receive UL communication signals from the remote units 105. Furthermore, the DL communication signals may be carried over the communication links 113. The communication links 113 may be any suitable carrier in licensed or unlicensed radio spectrum. The communication links 113 facilitate communication between one or more of the remote units 105 and/or one or more of the base units 111.

In one embodiment, the mobile core network 120 is a 5G core (“5GC”) or the evolved packet core (“EPC”), which may be coupled to a data network (e.g., the data network 130), such as the Internet and private data networks, among other data networks. A remote unit 105 may have a subscription or other account with the mobile core network 120. Each mobile core network 120 belongs to a single public land mobile network (“PLMN”). The present disclosure is not intended to be limited to the implementation of any particular wireless communication system architecture or protocol.

The mobile core network 120 includes several network functions (“NFs”). As depicted, the mobile core network 120 may include one or multiple user plane functions (“UPFs”) 121. A PDU session represents a logical connection between the remote unit 105 and the UPF 121. In order to establish the PDU session, the remote unit 105 must be registered with the mobile core network 120.

The mobile core network 120 also includes multiple control plane functions including, but not limited to, an Access and Mobility Management Function (“AMF”) 123, and a Session Management Function (“SMF”) 125, a Policy Control Function (“PCF”) 127, and a Unified Data Management function (“UDM”) 129. In certain embodiments, the mobile core network 120 may also include an Authentication Server Function (“AUSF”), a Network Repository Function (“NRF”) (used by the various NFs to discover and communicate with each other over APIs), a Network Exposure Function (“NEF”), or other NFs defined for the 5GC. In certain embodiments, the mobile core network 120 may include a AAA server.

In various embodiments, the mobile core network 120 supports different types of mobile data connections and different types of network slices, wherein each mobile data connection utilizes a specific network slice. Here, a “network slice” refers to a portion of the mobile core network 120 optimized for a certain traffic type or communication service. Each network slice includes a set of CP and/or UP network functions. A network instance may be identified by a S-NSSAI, while a set of network slices for which the remote unit 105 is authorized to use is identified by NSSAI (i.e., sequence of one or more S-NSSAI). In certain embodiments, the various network slices may include separate instances of network functions, such as the SMF 125 and UPF 121. In some embodiments, the different network slices may share some common network functions, such as the AMF 123. The different network slices are not shown in FIG. 1A for ease of illustration, but their support is assumed.

As discussed in further detail below, a PDU session may be established between the remote unit 105 and the UPF 121 with one or more QoS flows. Packets (i.e., PDUs) of the PDU session may be classified and marked with a QoS Flow Indicator (“QFI”). In a 5GS, QoS flows are mapped in the access network 110 to DRBs. A DRB established between the remote unit 105 and a base unit 111 may support one or more QoS flows. Examples of QoS flow types includes: GBR QoS flow (i.e., requires guaranteed flow bit rate), non-GBR QoS flow (i.e., does not require guaranteed flow bit rate), and Delay Critical QoS flow (i.e., for Mission Critical services and requiring a guaranteed flow bit rate).

Although specific numbers and types of network functions are depicted in FIG. 1A, one of skill in the art will recognize that any number and type of network functions may be included in the mobile core network 120. Moreover, where the mobile core network 120 is an EPC, the depicted network functions may be replaced with appropriate EPC entities, such as an MME, S-GW, P-GW, HSS, and the like. Note that in EPS, there may be a one-to-one mapping of QoS flow to radio bearer.

In the following descriptions, the term gNB is used for the base station but it is replaceable by any other radio access node, e.g., BS, eNB, gNB, AP, NR, etc. Further the operations are described mainly in the context of 5G NR. However, the proposed solutions/methods are also equally applicable to other mobile communication systems supporting serving cells/carriers being configured for QoS adaptation.

In 5GS, a serving base unit 111 (e.g., a serving gNB) initially subscribes to the intelligent control unit 115 (i.e., an AI-enabled function) to enable the feature of expected QoS adaptation pattern. The base unit 111 sends the QoS parameters for the QoS flow (and optionally radio parameters) to enable the AI function to perform on-line analytics based on channel quality measurements. Whether the measurements are real-time or near-real time depends on the deployment of the intelligent control unit 115 as co-located with the base unit 111 or as an external entity.

Following receipt of the QoS parameters, the intelligent control unit 115 collects data (e.g. radio parameters, UE location, traffic related statistics) and trains an AI model (or receives a trained AI model from the AI/ML model database 117, as alternative). The intelligent control unit 115 sends a QoS pattern to the base unit 111. Here, the intelligent control unit 115 translates the AI traffic/mobility model to an expected QoS adaptation pattern and sends the predictive QoS pattern to the base unit 111. Note that the base unit 111 may adapt parameters accordingly. In certain embodiments, the base unit 111 sends to the AMF 123 and/or the SMF 125 a request for a new QoS profile pattern for the QFI.

FIG. 1B depicts an O-RAN architecture 150 for configuring a predictive QoS adaptation pattern, according to embodiments of the disclosure. The O-RAN architecture includes a service and management plane 151 which includes a configuration, policy, inventory, and design function 152 and a non-real time RAN intelligent controller (“non-RT RIC”) 153, a near-real time RAN intelligent controller (“near-RT RIC”) 155, and a NR RAT plane 157. The non-RT RIC 153 and near-RT RIC 155 may comprise a distributed implementation of the intelligent control unit 115, discussed above. The NR RAT plane 157 includes at least one E2 node 173. The E2 node 172 may be one embodiment of the base unit 111, discussed above.

As depicted, the near-RT RIC 155 may include a plurality of applications (“xAPP”) 159 and near-RT RIC framework functions 161. In O-RAN, QoE/QoS optimization as possible AI-enabled feature which is deployed at the near-RT RIC 155 (as 3^{rd} party xAPP 159 or proprietary xAPP 159). In this context, the task of checking QoS upgrade/downgrade may be assisted by the use of the near-RT RIC 155 and the interfaces which need to be considered are Open APIs.

The non-RT RIC 153 is a logical function that enables non-real-time control and optimization of RAN elements and resources, AI/ML workflow including model training and updates, and policy-based guidance of applications/features in the near-RT RIC 155.

The near-RT RIC 155 and framework functions 161 are logical functions that enables near-real-time control and optimization of RAN elements and resources via fine-grained (e.g. UE basis, Cell basis) data collection and actions over E2 interface. The near-RT RIC 155 comprises near-RT RIC basic/framework functions 161 which can be for example subscription management 163, conflict mitigation 165, E2 termination (E2T) 167, an A1/O1 termination (A1T/O1T) 169, etc. As depicted, the near-RT RIC 155 may include a database 171 that supports the near-RT RIC basic/framework functions 161.

The Conflict Management/Mitigation function 165 is a function which is part of the near-RT RIC 155 and is used to avoid conflicting control messages from different xAPPs 159. Based on the output of conflict mitigation function 165, the E2T 167 generates only one reasonable control message on the E2 interface.

The Subscription Management function 163 is the functionality where xAPPs 159 subscribe for controlling E2 nodes 173. This function merges identical subscriptions from different xAPPs 159. Based on the output of subscription management, the E2 termination (E2T) 167 generates only one message to the E2 nodes 173.

An xAPP 159 is an application designed to run on the near-RT RIC 155. Such an application 159 is likely to consist of one or more microservices and at the point of on-boarding will identify which data it consumes and which data it provides. The xAPP 159 may be independent of the near-RT RIC 155 and may be proprietary or provided by any third party. The E2 enables a direct association between the xAPP 159 and the RAN functionality.

The AI interface refers to the interface between non-RT RIC 153 and the near-RT RIC 155 to enable policy-driven guidance of the near-RT RIC applications 159 and/or functions 161, and support AI/ML workflow. The O1 interface supports management functions between the O-RAN components. Open API is the interface between the framework functions 161 and xAPPs 159. The E2 interface is the interface connecting the near-RT RIC 155 and NR RAT plane 157. An E2 Node 173 is a logical node terminating E2 interface. For example, the E2 node may be an NR node, like O-CU-CP, O-CU-UP, O-DU, or a virtualized eNB.

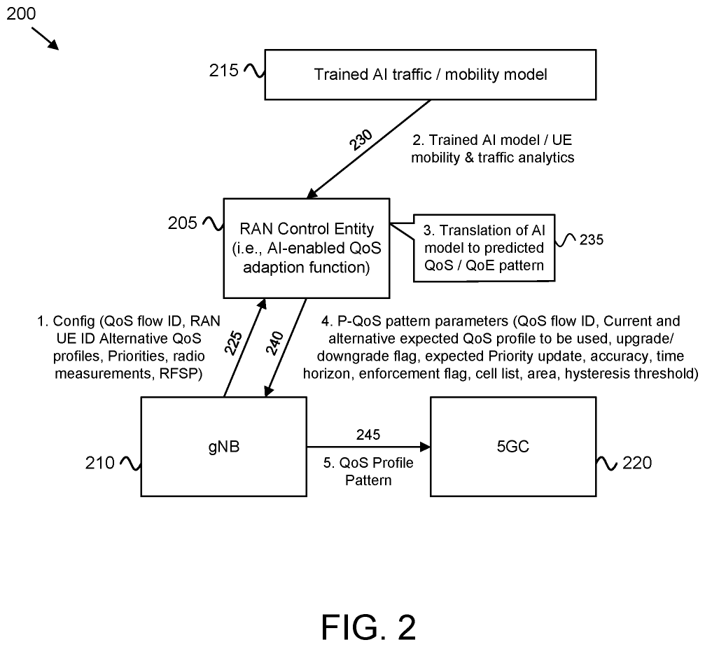

FIG. 2 depicts a procedure 200 for configuring a predictive QoS adaptation pattern, according embodiments of the disclosure. The procedure 200 involves a RAN control entity 205 (i.e., including an AI-enabled QoS adaptation function), a gNB 210, a trained AI-traffic/mobility model 215, and a 5G core network (“5GC”) 220. The RAN control entity 205 may be one embodiment of the intelligent control unit 115, the gNB 210 may be one embodiment of the base unit 111, and the 5GC 220 may be one embodiment of the mobile core network 120.

The steps of the procedure are as follows:

At step 1, the RAN control entity 205 receives (i.e., from serving gNB 210) the necessary QoS flow parameters from the serving RAN node (for the flow for which the checking of QoS upgrades/downgrades is going to be offloaded to the RAN control entity), including alternative QoS profiles with the QoS profile priorities (see messaging 225).

At step 2, upon receiving the QoS flow information, the RAN control entity 205 requests and obtains a trained AI/ML model (i.e., AI-traffic/mobility model 215) on the expected traffic of the target cell and/or the mobility for the respective UE (based on request or subscription, see messaging 230). To acquire the expected mobility of the UE, is its assumed that either the RAN control entity 205 is aware of the UE ID (IMEI/PEI, GPSI) and its mapping to RAN UE ID from the network, or this information is provided by the service provider (application function) along with the mobility pattern to the RAN control entity. Note that if the trained AI/ML model is not part of the RAN control entity 205, then the UE identifier needs to be also exposed to the entity providing the model (i.e., the AI/ML model database 117), in order to map the mobility pattern to the respective UE.

The AI/ML model(s) can be based on one of the following types:
1) Supervised learning model using training data based with a known label: algorithms for this category can vary e.g. regression, k-means NN, decision tree algorithms, SVN, Bayesian algorithms etc. This allows that the ML training host and the ML model host are either co-located within the same entity (e.g. centralized AI function) or distributed in different entities (e.g. non-RT RIC 153 and near-RT RIC 155).
2) Unsupervised learning model using unlabeled input data, some algorithms can be the k-means clustering and PCA. This allows that the ML training host and the ML model host are either co-located within the same entity (e.g. centralized AI function) or distributed in different entities (e.g. non-RT RIC 153 and near-RT RIC 155).
3) Reinforcement learning: in this type, the agent aims to optimize a long-term objective by interacting with the environment based on a trial and error process. Popular algorithms are the Deep Recursive Model, multi-armed bandit learning, Q-learning. This requires that the ML training host and the ML model host be co-located within the same entity (e.g. centralized AI function).

Note that one or more AI/ML trained models can be used as input to the RAN control entity 205, e.g., one for the UE mobility prediction and one for the RAN traffic prediction; in that case different types of models may require different interfaces/loops between the AI/ML training entity and the AI/ML inference host entity.

At step 3, the RAN control entity 205 translates the obtained AI/ML model to an expected QoS profile adaptation pattern (which can be either predictive or prescriptive QoS, see block 235). As used herein, an expected QoS profile adaptation pattern may be defined as an expected sequence of QoS profiles to be used for the flow for a given time interval. The expected QoS profile adaptation pattern is the result of the configuration which maps the AI/ML model to expected QoS fluctuations. The following conditions are checked pro-actively:
A) Whether current QoS profile is expected to remain the same and for what duration/time horizon, geographical area
B) Whether current QoS profile is expected to downgrade and to which alternative, at what time instance and for what duration/time horizon, geographical area, etc.
C) Whether current QoS profile is expected to upgrade to which alternative, at which time instance, for what duration/time horizon, geographical area

At step 4, the RAN control entity 205 provides the QoS adaptation pattern parameters to the serving RAN node (i.e., gNB 210), based on the determined expected QoS adaptation pattern (which may include the QoS profile transitions over a time period, time validity, area for which the change applies, see messaging 240).

At step 5, the gNB 210 decides whether to apply the QoS flow remapping or whether to solve any expected QoS changes using RAN-level decisions (e.g. scheduling, QoS flow to DRB re-mapping). If RAN node decides that this requires the QoS profile re-mapping, RAN informs AMF/SMF on the expected QoS adaptation pattern for the QoS flow (instead of a single QoS profile change as is done conventionally, see messaging 245).

One particular example for the solution applicability can be the scenario when a vehicular UE is moving in a certain urban area. The AI/ML model (i.e., AI-traffic/mobility model 215) which provides the expected mobility pattern of the UE (sequence of location coordinates in a given area between point A and point B, which can be provided by the application based on the selected route at the GPS) will be processed together with the AI/ML model which gives the expected radio channel conditions and traffic demand per cell in the same area (point A to point B), based on historical data analytics. This will derive the SINR/data rata curve which applies for this area and time when the UE is planned to move. Based on the use of the AI/ML models, the AI-enabled QoS function will translate the expected radio conditions over this area, in conjunction with the QoS requirements, to a series of QoS profile changes over this time horizon. RAN may then use this information to adapt its behavior to meet the QoS requirements of that UE.

Note that the above description of steps 3 and 4 discuss a QoS profile adaptation pattern; however, the present solution is not limited to the QoS profile but can be extended to QoE too. In that case in Step 5, the gNB 210 may undertake the task to translate the QoE adaptation pattern (expected service experience, e.g. MOS scores, for a given time duration) to QoS profile adaptation pattern.

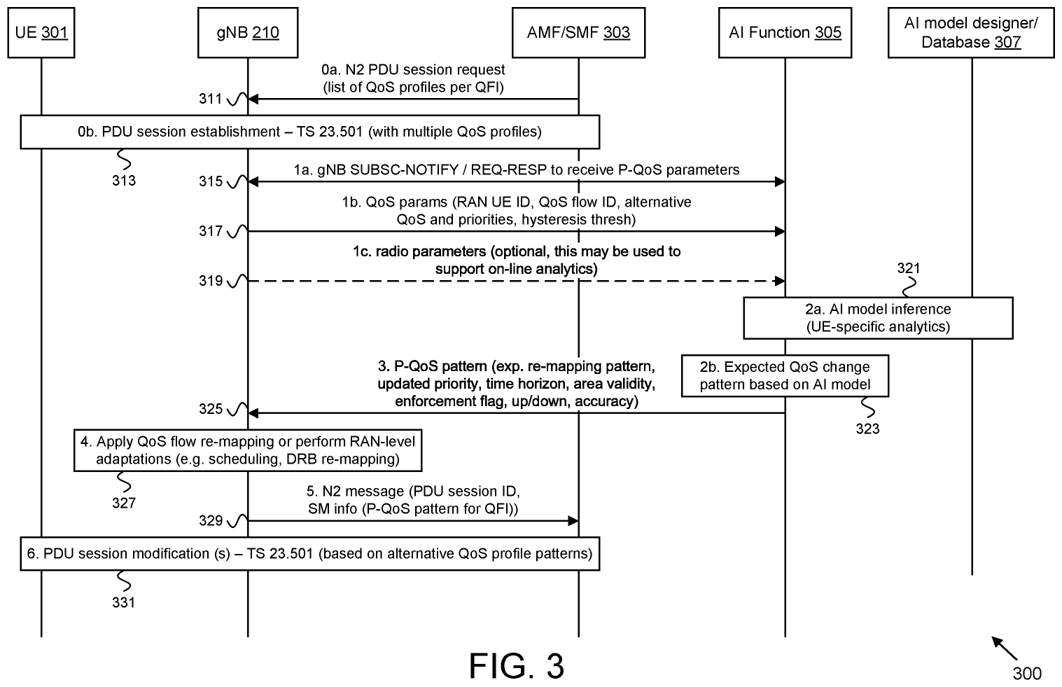

FIG. 3 depicts signaling flow for one embodiment of a 5GS-implemented procedure 300 for AI-assisted QoS profile pattern prediction and adaptation, according embodiments of the disclosure. The procedure 300 involves a UE 301 (i.e., one embodiment of the remote unit 105), the gNB 210, an AMF and SMF in 5GC (depicted as “AMF/SMF” 303), an AI function 305 (i.e., one embodiment of the intelligent control unit 115 and/or RAN control entity 205), and an AI/ML model designer/database 307 (i.e., the AI/ML model designer 117 (e.g., 3^{rd} party) or the database 171 (assuming that a database is storing the UE- and RAN-related analytics). The steps of the procedure 300 are described as follows:

At Steps 0a, the 5GC (SMF via AMF) provides to the gNB 210 a N2 PDU session request with the list of QoS profiles for the QoS flow (see messaging 311). At step Ob, a PDU session establishment procedure is triggered with multiple QoS levels (see block 313). In various embodiments, both steps 0a and Ob may be performed as specified in 3GPP TS 23.501/23.502.

At Step 1a, the gNB 210 subscribes to the AI function 305 to be notified on predictive and/or prescriptive analytics on the expected QoS adaptation pattern (see messaging 315). Alternatively, the gNB 210 performs a one-time request to receive analytics and in this request, it configures the reporting which is needed by the AI function 305 (e.g., format, accuracy, periodicity, type of analytics). This is followed by a response (ACK/NACK) from the AI function 305 as acknowledgement. In the request/subscription message, the gNB 210 can also request the type of AI/ML model to be used, or the expected accuracy/training configuration (and let the AI function 305 apply the most preferable algorithm).

At Step 1b, the gNB 210, after the subscription/request for receiving the expected QoS adaptation pattern, provides the QoS parameters which are needed at the AI function to provide predictive/prescriptive analytics (see messaging 317). These QoS parameters may include one or more of the following:
QoS flow ID (s)/session ID/UE ID
List of QoS profiles (original and alternatives)
Priorities of QoS profiles
Geographical area
Time validity
Hysteresis threshold
S-NSSAI

At Step 1c, the gNB 210 may also provide radio parameters to support the AI function 305 on its decision (see messaging 319). This information is needed for supporting on-line analytics at the AI function 305 using real-time/near-real time measurements from the gNB 210 which is serving the UE 301. This message may be sent periodically (the radio parameters requirements and the periodicity are based on configuration at step 1a) in order to allow the AI function 305 to collect enough data for enhancing the AI/ML model with up-to-date channel information. However, what radio parameters to be exposed depend on the deployment of the AI function 305 (this is due to the fact that the deployment may impose latency limitations for getting up-to-date parameters). These radio parameters may include one or more of the following:
CSI (CQI, PMI, RI) measurements
RRM/RLM measurements
RRC user/cell parameters
RRM function outputs (e.g. ICIC/eICIC info)
Slice related parameters (e.g. slice capacity, slice RRM policies)
UE context parameters (UE location, mobility/velocity)

At Step 2a, the AI function 305 interacts with the AI/ML model designer/database 307 to fetch the data required to perform AI model inference (see block 321). In this step the model is trained; and the model can be related to the UE expected behavior (e.g., expected location, traffic demand, sequence of handovers) and/or RAN expected status (e.g., expected performance downgrade, expected UL/DL traffic demand, expected backhaul conditions, expected DRB load) for a given time frame and area.

At Step 2b, the AI function 305 translates the trained AI model to an expected QoS adaptation pattern for the respective QoS flow (see block 323). Here, the AI function 305 considers the list of QoS profiles and their priorities, the type of analytics (prescriptive, predictive), the expected UE behavior and/or RAN behavior, the hysteresis threshold (which may impact the number of allowed transitions), the expected accuracy of the prediction which may be configured per area within the cell.

Based on this translation, the AI function 305 determines the expected QoS adaptation pattern mapping for the QoS flow of the UE 301. This may also include a tuning of the hysteresis threshold for a given time or area (e.g., when the UE 301 is within a tunnel) to capture some deep QoS downgrades within a pre-defined hysteresis.

At Step 3, the AI function 305 sends a report with the expected QoS adaptation pattern for the QoS flow to the gNB (see messaging 325). Note that if Step 1a is based on subscription, this is a NOTIFY message. The predictive QoS report includes one or more of the following:
QoS flow ID, session ID, UE ID
An expected QoS adaptation pattern in the form of a list (<QoS flow, QoS profile x, y, . . . , t1, t2, . . . >) or table per flow (QoS profile×Time instances)
tuning of hysteresis threshold and cause
accuracy of prediction per area (within the cell or per cell) and time
area of validity and time horizon for the prediction
enforcement flag (whether the QoS profile pattern needs to be enforced or it allows RAN to take further actions, e.g. DRB remapping)
upgrade or downgrade indication per QoS transition
type of analytics used (predictive or prescriptive)

At Step 4, the gNB 210, upon receiving the report, evaluates whether the expected QoS adaptation pattern requires the adaptation of QoS profile pattern (based on the enforcement flag, accuracy) and the possible change of hysteresis threshold, or some action can be performed at the RAN level to avoid adapting the QoS profile (e.g. scheduling, adaptation of DRB resources/mapping) (see block 327).

At Step 5, the gNB 210 sends to SMF via AMF an N2 message to indicate the expected QoS adaptation pattern for the QFI (see messaging 329). This N2 message is modified as compared to the conventional message specified in 3GPP TS 23.502. The modified N2 message includes the expected QoS adaptation pattern, and not only an individual QoS profile that needs to change for the QoS flow.

According to 3GPP TS 23.502, the N2 SM information includes the QFI and an indication that the QoS targets for that QoS Flow cannot be fulfilled or can be fulfilled again, respectively. When QoS targets cannot be fulfilled, the N2 SM information indicates a reference to the Alternative QoS Profile matching the values of the QoS parameters that the NG-RAN is currently fulfilling. In Step 5, the N2 SM information also includes the QoS profile pattern, which can be in the form of a list (<QFI, QoS profile x, y, . . . , t1, t2, . . . >) or table per QFI (QoS profile×Time instances).

At Step 6, the PDU session modifications are triggered (e.g., based on 3GPP TS 23.501/502, see block 331). A main difference between the procedure 300 and the current 3GPP specification is that in the procedure 300 this is based on the alternative QoS profile patterns (and may require further modification in predefined time periods).

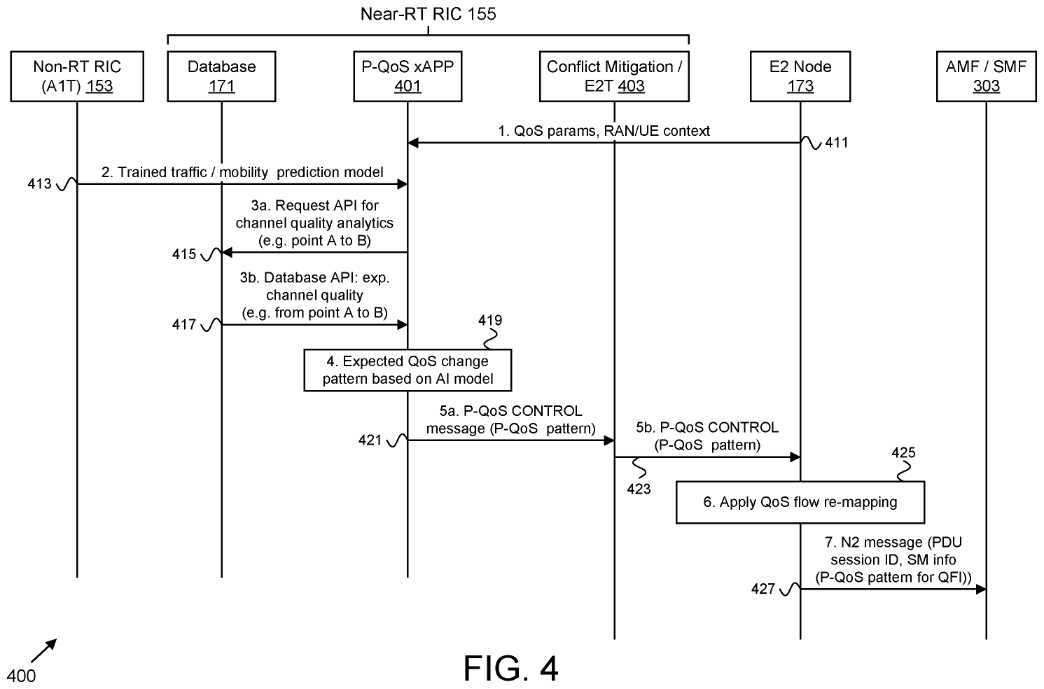

FIG. 4 depicts signaling flow for one embodiment of an O-RAN-implemented procedure 400 for AI-assisted QoS profile pattern prediction and adaptation, according to embodiments of the disclosure. The procedure 400 involves the non-RT RIC 153 (i.e., via an AI termination 169), the near-RT RIC 155 (including a P-QoS xAPP 401), and E2 node 173 and the AMF and SMF in the 5GC (again denoted as “AMF/SMF” 303).

The embodiment of FIG. 4 targets the O-RAN scenario (a RAN node is considered as E2 node 173, the RAN control entity 205 is the P-QoS xAPP 401 residing at the near-RT RIC 155), where an xAPP (denoted as Predictive-QoS or P-QoS xAPP) is the application function which performs the checking and decision on the expected QoS adaptation pattern, using predictive/prescriptive analytics. The steps of the procedure 400 are described as follows:

As a pre-condition, it is assumed that the P-QoS xAPP 401 has subscribed to receive QoS parameters for specific area or specific UEs from E2 node 173 (e.g., gNB 210 equivalent) via the RIC platform. In addition, it is assumed that one or more PDU sessions are established for the respective UEs (note that the UEs are note depicted in FIG. 4).

At Step 1, the serving E2 node 173 (aka a RAN node) sends via E2 interface, the necessary QoS configuration parameters (for the QoS flow) to the P-QoS xAPP 401 (see messaging 411). This includes the QoS flow ID, RAN UE ID, list of QoS profiles, priorities, time horizon, accuracy required, Geographical area, Time validity, Hysteresis threshold, S-NSSAI. The E2 node 173 may also provide radio parameters (over E2SM), periodically or based on radio-related monitoring events, to support the P-QoS xAPP 401 on its decision. This information is needed for supporting on-line analytics at the P-QoS xAPP 401 using real-time measurements from the serving E2 node 173. However, the radio parameters to be exposed depend on the deployment of the P-QoS xAPP 401 (which may impose latency limitations).

These parameters provided by the E2 node may include one or more of the following:
averaged/abstracted CSI measurements
RRM/RLM measurements
RRC user/cell parameters
RRM function outputs (e.g. ICIC/eICIC info)
Slice related parameters (e.g. slice capacity, slice RRM policies)
UE context parameters (UE location, mobility/velocity)

At Step 2, a trained AI/ML model is sent to P-QoS xAPP 401 by the non-RT RIC 153 over AI interface/Open API (see messaging 413). Alternatively, the trained AI/ML model may be sent by the near-RT RIC 155 via Open API. The trained the model can be related to the UE expected behavior (expected location, traffic demand, sequence of handovers) and/or RAN expected status (expected performance downgrade, expected UL/DL traffic demand, expected backhaul conditions, expected DRB load) for a given time frame and area. Here, prior receiving the trained model, the P-QoS xAPP 401 may also request the type of AI/ML model to be used, or the expected accuracy/training configuration.

At Step 3a and 3b, the P-QoS xAPP 401 also interacts with the corresponding Database 171 (assuming that a Database at the near-RT RIC 155 is storing the UE- and RAN-related analytics), to request (see messaging 415) and fetch (see messaging 417) the data required to perform AI enabled QoS policy decision, taking into account the UE route. In other words, the P-QoS xAPP 401 consumes Database Open API to receive channel quality fluctuations in the given area where the UE moves (which is based on off-line analytics).

As an example, the P-QoS xAPP 401 may consume Database APIs to obtain the wireless channel analytics (SINR distribution) based on the expected route that the UE may follow (based on the received AI model of Step 2).

At Step 4, the P-QoS xAPP 401 translates the trained AI model (considering also the Database APIs) to an expected QoS adaptation pattern for the respective QoS flow (see block 419). Here, the P-QoS xAPP 401 considers the list of QoS profiles and their priorities, the expected UE and/or RAN behavior, the hysteresis threshold (which may impact the number of allowed transitions), the expected accuracy of the prediction which may be configured per area within the cell.

As a particular example, the P-QoS xAPP 401 may translate the channel quality fluctuations to derivation of a QoS profile pattern for the QoS flow of the UE. The criteria for selection may also be:
Hypothetical benefit of change (QoE enhancement vs service disruption/outage)
Calculation of cost for change (signaling cost as function of e2e delay, including propagation and processing delays near-RT-RIC-to-gNB-to-SMF-to-gNB-to-UE)
Filter frequent changes due to hysteresis threshold (keep the sub-optimal or proactively change QoS to be in-line with the threshold)
Impact to other UEs, e.g. 5QI load may be increased due to a change
Type of traffic (e.g., bursty)

Based on this translation, the P-QoS xAPP 401 generates the QoS flow to QoS profile adaptation pattern mapping table/list. This may also include a tuning of the hysteresis threshold for a given time or area (e.g. in a tunnel) to capture some deep QoS downgrades within a pre-defined hysteresis.

At Step 5a/5b, the P-QoS xAPP 401 sends a CONTROL report message with the expected QoS adaptation pattern for the QoS flow to the E2 node via E2 interface/Open API (which may be further processed at the RIC platform by Conflict Mitigation and/or E2T, before reaching the E2 node in order to check for any conflict with other similar xAPPs, see messaging 421, 423). This predictive QoS report includes one or more of the following:
QoS flow ID, session ID, UE ID
An expected QoS adaptation pattern in the form of a list (<QoS flow, QoS profile x, y, . . . , t1, t2, . . . >) or table per flow (QoS profile×Time instances)
tuning of hysteresis threshold and cause
accuracy of prediction per area (within the cell or per cell) and time
area of validity and time horizon for the prediction
enforcement flag (whether the QoS profile pattern needs to be enforced or it allows RAN to take further actions, e.g. DRB remapping)
upgrade or downgrade indication per QoS transition

At Step 6, the E2 node 173 (e.g., E2 agent), upon receiving the report, evaluates whether the QoS pattern requires the adaptation of QoS profile pattern (based on the enforcement flag, accuracy) and the possible change of hysteresis threshold, or some action can be performed at the RAN level to avoid adapting the QoS profile (e.g., scheduling, adaptation of DRB resources/mapping, see block 425).

At Step 7, the E2 node 173, sends to SMF via AMF an N2 message to indicate the predictive QoS pattern for the QFI. The N2 message is a modified message that includes the predictive QoS profile pattern (see messaging 427). Note that according to 3GPP TS 23.502, the N2 SM information includes the QFI and an indication that the QoS targets for that QoS Flow cannot be fulfilled or can be fulfilled again, respectively. When QoS targets cannot be fulfilled, the N2 SM information indicates a reference to the Alternative QoS Profile matching the values of the QoS parameters that the NG-RAN is currently fulfilling. However, in step 7 the N2 SM information shall also include the QoS profile pattern, which can be in the form of a list (<QFI, QoS profile x, y, . . . , t1, t2, . . . >) or table per QFI (QoS profile×Time instances).

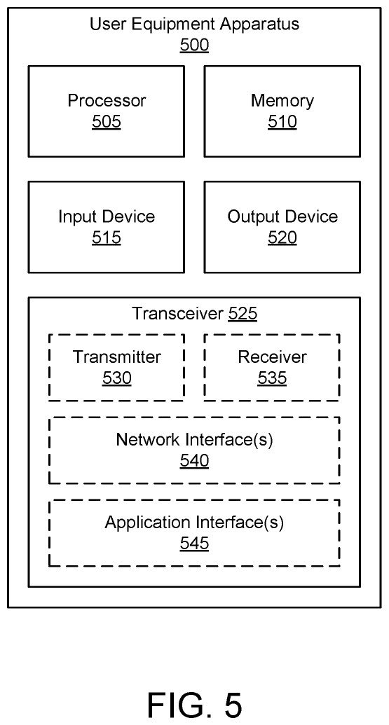

FIG. 5 depicts a user equipment apparatus 500 that may be used for configuring an expected QoS adaptation pattern, according to embodiments of the disclosure. In various embodiments, the user equipment apparatus 500 is used to implement one or more of the solutions described above. The user equipment apparatus 500 may be one embodiment of a UE and its supporting hardware, such as the remote unit 105 and/or the UE 301, described above. Furthermore, the user apparatus 500 may include a processor 505, a memory 510, an input device 515, an output device 520, and a transceiver 525. In some embodiments, the input device 515 and the output device 520 are combined into a single device, such as a touchscreen. In certain embodiments, the user apparatus 500 may not include any input device 515 and/or output device 520. In various embodiments, the user apparatus 500 may include one or more of: the processor 505, the memory 510, and the transceiver 525, and may not include the input device 515 and/or the output device 520.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a FPGA, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In various embodiments, the processor 505 controls the user apparatus 500 to implement the above described UE behaviors.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to configuring a predictive QoS adaptation pattern. For example, the memory 510 may store policies, parameters, and the like. In certain embodiments, the memory 510 also stores program code and related data, such as an operating system or other controller algorithms operating on the user equipment apparatus 300.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the user apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

As discussed above, the transceiver 525 communicates with one or more base units 111. Due to mobility/travel of the user equipment apparatus 500, the transceiver 525 may be involved with handover from one base unit 111 to another. The transceiver 525 operates under the control of the processor 505 to transmit messages, data, and other signals and also to receive messages, data, and other signals. For example, the processor 505 may selectively activate the transceiver (or portions thereof) at particular times in order to send and receive messages.

In various embodiments, the transceiver 525 is configured to communication with 3GPP access network(s) and/or the non-3GPP access network(s). In some embodiments, the transceiver 525 implements modem functionality for the 3GPP access network(s) and/or the non-3GPP access network(s). In one embodiment, the transceiver 525 implements multiple logical transceivers using different communication protocols or protocol stacks, while using common physical hardware.

In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum. In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540 or application interface 545.

The transceiver 525 may include one or more transmitters 530 and one or more receivers 535. Although a specific number of transmitters 530 and receivers 535 are illustrated, the user equipment apparatus 500 may have any suitable number of transmitters 530 and receivers 535. Further, the transmitter(s) 530 and the receiver(s) 535 may be any suitable type of transmitters and receivers. In certain embodiments, the one or more transmitters 530 and/or the one or more receivers 535 may share transceiver hardware and/or circuitry. For example, the one or more transmitters 530 and/or the one or more receivers 535 may share antenna(s), antenna tuner(s), amplifier(s), filter(s), oscillator(s), mixer(s), modulator/demodulator(s), power supply, and the like.

In various embodiments, the transceiver 525 is capable of communicating with a mobile core network via an access network. Accordingly, the transceiver 525 may support at least one network interface 540. Here, the at least one network interface 540 facilitates communication with a RAN node, such as an eNB or gNB, for example using the “Uu” interface (e.g., LTE-Uu for eNB, NR-Uu for gNB). Additionally, the at least one network interface 540 may include an interface used for communications with one or more network functions in the mobile core network, such as a UPF 121, an AMF 123, and/or a SMF 125. In certain embodiments, the transceiver 525 may support a PC5 interface for sidelink communication. The transceiver 525 and/or processor 505 may support one or more application interfaces 545. The application interface(s) 545 may support the APIs discussed herein. The network interface(s) 540 may support the 3GPP, ETSI, and/or O-RAN reference points discussed herein.

In various embodiments, one or more transmitters 530 and/or one or more receivers 535 may be implemented and/or integrated into a single hardware component, such as a multi-transceiver chip, a system-on-a-chip, an application-specific integrated circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module. In certain embodiments, the transceiver 525 may implement a 3GPP modem (e.g., for communicating via NR or LTE access networks) and a non-3GPP modem (e.g., for communicating via Wi-Fi or other non-3GPP access networks).

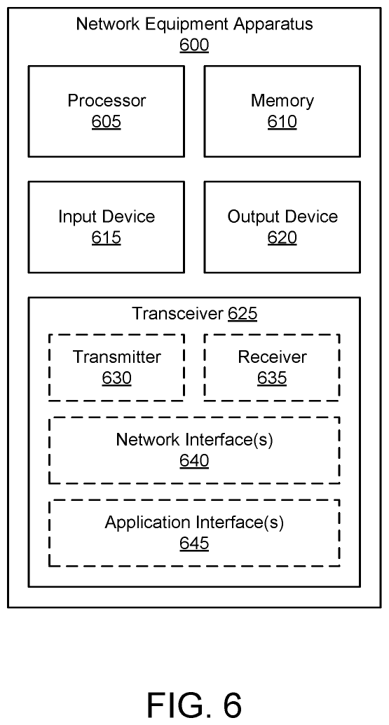

FIG. 6 depicts one embodiment of a network equipment apparatus 600 that may be used for configuring a predictive QoS adaptation pattern, according to embodiments of the disclosure. In some embodiments, the network apparatus 600 may be one embodiment of an intelligent control unit and its supporting hardware, such as the intelligent control unit 115, the near-RT RIC 155, an xAPP 159 (e.g., proprietary of 3rd party), the RAN control entity 210, the AI function 305, and/or the P-QoS xAPP 401, described above. Furthermore, network equipment apparatus 600 may include a processor 605, a memory 610, an input device 615, an output device 620, and a transceiver 625. In some embodiments, the input device 615 and the output device 620 are combined into a single device, such as a touch screen. In certain embodiments, the network equipment apparatus 600 does not include any input device 615 and/or output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support the APIs discussed herein. The network interface(s) 640 may support the 3GPP, ETSI, and/or O-RAN reference points discussed herein. In some embodiments, the transceiver 625 supports an interface (e.g., a E2 interface) for communicating with a RAN node. Other network interfaces may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the network equipment apparatus 600 to implement the above described AI function behaviors. For example, the processor 605 may receive (i.e., via the interface(s) 640/645) a QoS parameter for at least one QoS flow, the at least QoS flow corresponding to at least one UE. In some embodiments, the QoS parameter includes at least one of the following: a QoS flow ID, a session ID and a UE ID; a prioritized list of QoS profiles, the list including an original QoS profile and at least one alternative QoS profile; a geographical area; a time validity; a hysteresis threshold; and a network slice identifier (i.e., S-NSSAI).

In some embodiments, the processor 605 receives from at least one serving RAN node (e.g., via the interface(s) 640/645 and after receiving QoS parameters) at least one of the following radio parameters: averaged CSI; abstracted CSI measurements; RRM measurements; RLM measurements; RRC parameters for a user; RRC parameters for a cell; RRM function outputs; parameters for a network slice (e.g., slice capacity, slice RRM policies); and UE context parameters (e.g., UE location, UE mobility/velocity).

The processor 605 obtains a data analytics model. Here, the data analytics model describes at least one expected condition for the at least one UE and/or the at least one serving RAN node. In certain embodiments, the data analytics model is a trained AI model including at least one of: expected RAN resource conditions (e.g., channel statistics distribution over the entire area with highs and lows) for a future duration (e.g., the next 10 ms to 1 sec—based on the configuration and accuracy of prediction); expected wireless backhaul resource conditions (i.e., channel statistics distribution for the involved backhaul links) for the future duration (i.e., the next 10 ms to 1 sec—based on the configuration and the accuracy of prediction); an expected UE mobility pattern and/or expected UE trajectories for each UE in a service area (e.g., based on the accuracy of prediction); an expected channel quality fluctuation in an expected route of the at least one UE; and expected performance metrics for one or more selected UEs in the service area.

The processor 605 determines an expected QoS profile adaptation pattern from the data analytics model for a first time interval. Here, the expected QoS profile adaptation pattern comprises a sequence of QoS profiles to be used for the at least one QoS flow during the first time interval. In certain embodiments, the first time interval contains a second time interval and a third time interval, where the expected QoS profile adaptation pattern includes a first QoS profile for the second time interval and a second QoS profile for the third time interval, the second QoS profile different than the first QoS profile.

In some embodiments, determining the expected QoS profile adaptation pattern from the data analytics model for the first time interval includes mapping expected conditions to a plurality of QoS profiles, wherein the expected conditions are predicted by the AI model. In certain embodiments, the expected QoS profile adaptation pattern indicates at least one of: whether a current QoS profile is expected to remain the same for at least one of the first, second and third time intervals and/or for a geographical area; whether a current QoS profile is expected to downgrade to a different QoS profile for at least one of the first, second and third time intervals and/or for a geographical area; and whether a current QoS profile is expected to upgrade to a different QoS profile for at least one of the first, second and third time intervals and/or for a geographical area.

The processor 605 transmits (i.e., via the interface(s) 640/645) the expected QoS profile adaptation pattern to at least one network node associated with the QoS flow. In some embodiments, the processor 605 receives from the at least one serving RAN node (e.g., via the interface(s) 640/645 and before receiving the QoS parameters) a request to determine the expected QoS profile adaptation pattern. Here, the processor 605 transmits the expected QoS profile adaptation pattern to the at least one serving RAN node (e.g., a gNB or E2 node serving the at least one UE).

For example, the processor 605 may send a predictive QoS report to the at least one serving RAN node. In such embodiments, the predictive QoS report may include the expected QoS profile adaptation pattern and at least one of the following: a QoS flow ID, a session ID and a UE ID; a tuning of a hysteresis threshold; an accuracy of prediction; an area and time of validity; an enforcement flag indicating whether the expected QoS profile adaptation pattern is to be enforced; an upgrade or downgrade indication for each QoS transition in the expected QoS profile adaptation pattern; and a type of analytics used.

In certain embodiments, the at least one serving RAN node determines whether the expected QoS profile adaptation pattern requires QoS profile remapping or RAN-level adaptation. In certain embodiments, the at least one serving RAN node transmits to a core network function in response to determining that expected QoS profile adaptation pattern requires QoS profile remapping. Here, said transmission includes a QoS flow indicator and indicates at least one alternative QoS profile.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media. In some embodiments, the memory 610 stores data relating to configuring a expected QoS adaptation pattern, for example storing a QoS flow ID, a session ID and a UE ID, a hysteresis threshold, an accuracy of prediction, an area and time of validity, an enforcement flag, an expected QoS profile adaptation pattern, a type of analytics used, and the like. In certain embodiments, the memory 610 also stores program code and related data, such as an operating system (“OS”) or other controller algorithms operating on the network equipment apparatus 600 and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, may include any known electronically controllable display or display device. The output device 620 may be designed to output visual, audible, and/or haptic signals. In some embodiments, the output device 620 includes an electronic display capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, all or portions of the output device 620 may be located near the input device 615.

As discussed above, the transceiver 625 may communicate with one or more remote units and/or with one or more interworking functions that provide access to one or more PLMNs. The transceiver 625 may also communicate with one or more network functions (e.g., in the mobile core network 120). The transceiver 625 operates under the control of the processor 605 to transmit messages, data, and other signals and also to receive messages, data, and other signals. For example, the processor 605 may selectively activate the transceiver (or portions thereof) at particular times in order to send and receive messages.

The transceiver 625 may include one or more transmitters 630 and one or more receivers 635. In certain embodiments, the one or more transmitters 630 and/or the one or more receivers 635 may share transceiver hardware and/or circuitry. For example, the one or more transmitters 630 and/or the one or more receivers 635 may share antenna(s), antenna tuner(s), amplifier(s), filter(s), oscillator(s), mixer(s), modulator/demodulator(s), power supply, and the like. In one embodiment, the transceiver 625 implements multiple logical transceivers using different communication protocols or protocol stacks, while using common physical hardware.

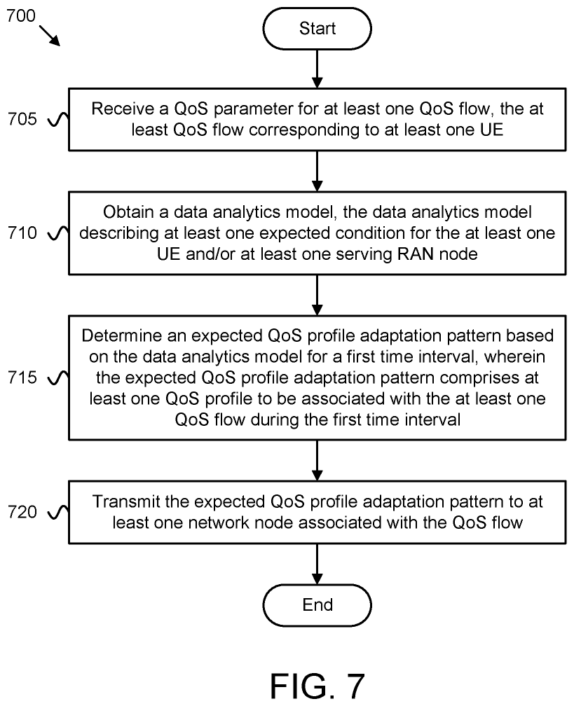

FIG. 7 depicts one embodiment of a method 700 for configuring a predictive QoS adaptation pattern, according to embodiments of the disclosure. In various embodiments, the method 700 is performed by an intelligent control unit, such as the intelligent control unit 115, the near-RT RIC 155, an xAPP 159 (e.g., proprietary of 3rd party), the RAN control entity 210, the AI function 305, the P-QoS xAPP 401, and/or network equipment apparatus 600, described above. In some embodiments, the method 700 is performed by a processor, such as a microcontroller, a microprocessor, a CPU, a GPU, an auxiliary processing unit, a FPGA, or the like.

The method 700 begins and receives 705 a QoS parameter for at least one QoS flow, the at least QoS flow corresponding to at least one UE. The method 700 includes obtaining 710 a data analytics model, the data analytics model describing at least one expected condition for the at least one UE and/or at least one serving RAN node. The method 700 includes determining 715 an expected QoS profile adaptation pattern based on the data analytics model for a first time interval, wherein the expected QoS profile adaptation pattern comprises at least one QoS profile to be associated with the at least one QoS flow during the first time interval. The method 700 includes transmitting 720 the expected QoS profile adaptation pattern to at least one network node associated with the QoS flow. The method 700 ends.

Disclosed herein is a first apparatus for configuring a predictive QoS adaptation pattern, according to embodiments of the disclosure. The first apparatus may be implemented by a an intelligent control unit, such as the intelligent control unit 115, the near-RT RIC 155, an xAPP 159 (e.g., proprietary of 3rd party), the RAN control entity 210, the AI function 305, the P-QoS xAPP 401, and/or network equipment apparatus 600. The first apparatus includes an interface that receives a QoS parameter for at least one QoS flow, the at least QoS flow corresponding to at least one UE. The first apparatus also includes a processor that obtains a data analytics model and determines an expected QoS profile adaptation pattern based on the data analytics model for a first time interval. Here the data analytics model describes at least one expected condition for the at least one UE and/or at least one serving RAN node, where the expected QoS profile adaptation pattern comprises at least one QoS profile to be associated with the at least one QoS flow during the first time interval. The processor transmits, via the interface, the expected QoS profile adaptation pattern to at least one network node associated with the QoS flow.

In certain embodiments, the first time interval contains a second time interval and a third time interval, where the expected QoS profile adaptation pattern comprises a sequence of QoS profiles to be used for the at least one QoS flow, including a first QoS profile for the second time interval and a second QoS profile for the third time interval, the second QoS profile different than the first QoS profile.

In certain embodiments, the expected QoS profile adaptation pattern indicates at least one of: whether a current QoS profile is expected to remain the same for at least one of the first, second and third time intervals and/or for a geographical area; whether a current QoS profile is expected to downgrade to a different QoS profile for at least one of the first, second and third time intervals and/or for a geographical area; and whether a current QoS profile is expected to upgrade to a different QoS profile for at least one of the first, second and third time intervals and/or for a geographical area.

In some embodiments, the processor receives (e.g., before receiving the QoS parameters) from the at least one serving RAN node a request to determine the expected QoS profile adaptation pattern. Here, transmitting the expected QoS profile adaptation pattern includes transmitting to the at least one serving RAN node (e.g., a gNB or E2 node serving the at least one UEL).

In some embodiments, transmitting the expected QoS profile adaptation pattern includes sending a predictive QoS report to the at least one serving RAN node. In such embodiments, the predictive QoS report may include the expected QoS profile adaptation pattern and at least one of the following: a QoS flow ID, a session ID and a UE ID; a tuning of a hysteresis threshold; an accuracy of prediction; an area and time of validity; an enforcement flag indicating whether the expected QoS profile adaptation pattern is to be enforced; an upgrade or downgrade indication for each QoS transition in the expected QoS profile adaptation pattern; and a type of analytics used.

In certain embodiments, the RAN node determines whether the expected QoS profile adaptation pattern requires QoS profile remapping or RAN-level adaptation. In certain embodiments, the RAN node transmits to a core network function in response to determining that expected QoS profile adaptation pattern requires QoS profile remapping. Here, said transmission includes a QoS flow indicator and indicates at least one alternative QoS profile.

In some embodiments, the QoS parameters include at least one of the following: a QoS flow ID, a session ID and a UE ID; a prioritized list of QoS profiles, the list including an original QoS profile and at least one alternative QoS profile; a geographical area; a time validity; a hysteresis threshold; and a network slice identifier (i.e., S-NSSAI).

In some embodiments, the processor receives (e.g., after receiving QoS parameters) from the at least one serving RAN node at least one of the following radio parameters: averaged CSI; abstracted CSI measurements; RRM measurements; RLM measurements; RRC parameters for a user; RRC parameters for a cell; RRM function outputs; parameters for a network slice (e.g., slice capacity, slice RRM policies); and UE context parameters (e.g., UE location, UE mobility/velocity).

In certain embodiments, the data analytics model is a trained AI model including at least one of: expected RAN resource conditions (e.g., channel statistics distribution over the entire area with highs and lows) for a future duration (e.g., the next 10 ms to 1 sec—based on the configuration and accuracy of prediction); expected wireless backhaul resource conditions (i.e., channel statistics distribution for the involved backhaul links) for the future duration (i.e., the next 10 ms to 1 sec—based on the configuration and the accuracy of prediction); an expected UE mobility pattern and/or expected UE trajectories for each UE in a service area (e.g., based on the accuracy of prediction); an expected channel quality fluctuation in an expected route of the at least one UE; and expected performance metrics for one or more selected UEs in the service area.

In some embodiments, determining the expected QoS profile adaptation pattern from the data analytics model for the first time interval includes mapping expected conditions to a plurality of QoS profiles, wherein the expected conditions are predicted by the AI model.

Disclosed herein is a first method for configuring a predictive QoS adaptation pattern, according to embodiments of the disclosure. The first method may be performed by a an intelligent control unit, such as the intelligent control unit 115, the near-RT RIC 155, an xAPP 159 (e.g., proprietary of 3rd party), the RAN control entity 210, the AI function 305, the P-QoS xAPP 401, and/or network equipment apparatus 600. The first method includes receiving a QoS parameter for at least one QoS flow, where the at least QoS flow corresponding to at least one UE. The first method includes obtaining a data analytics model, the data analytics model describing at least one expected condition for the at least one UE and/or at least one serving RAN node and determining an expected QoS profile adaptation pattern based on the data analytics model for a first time interval. Here, the expected QoS profile adaptation pattern comprises at least one QoS profile to be associated with the at least one QoS flow during the first time interval. The first method includes transmitting the expected QoS profile adaptation pattern to at least one network node associated with the QoS flow.

In certain embodiments, the first time interval contains a second time interval and a third time interval, where the expected QoS profile adaptation pattern comprises a sequence of QoS profiles to be used for the at least one QoS flow, including a first QoS profile for the second time interval and a second QoS profile for the third time interval, the second QoS profile different than the first QoS profile.

In certain embodiments, the expected QoS profile adaptation pattern indicates at least one of: whether a current QoS profile is expected to remain the same for at least one of the first, second and third time intervals and/or for a geographical area; whether a current QoS profile is expected to downgrade to a different QoS profile for at least one of the first, second and third time intervals and/or for a geographical area; and whether a current QoS profile is expected to upgrade to a different QoS profile for at least one of the first, second and third time intervals and/or for a geographical area.

In some embodiments, the first method includes (e.g., before receiving the QoS parameters) receiving from the at least one serving RAN node a request to determine the expected QoS profile adaptation pattern. Here, transmitting the expected QoS profile adaptation pattern includes transmitting to the at least one serving RAN node (e.g., a gNB or E2 node serving the at least one UEL).

In some embodiments, transmitting the expected QoS profile adaptation pattern includes sending a predictive QoS report to the at least one serving RAN node. In such embodiments, the predictive QoS report may include the expected QoS profile adaptation pattern and at least one of the following: a QoS flow ID, a session ID and a UE ID; a tuning of a hysteresis threshold; an accuracy of prediction; an area and time of validity; an enforcement flag indicating whether the expected QoS profile adaptation pattern is to be enforced; an upgrade or downgrade indication for each QoS transition in the expected QoS profile adaptation pattern; and a type of analytics used.

In certain embodiments, the RAN node determines whether the expected QoS profile adaptation pattern requires QoS profile remapping or RAN-level adaptation. In certain embodiments, the RAN node transmits to a core network function in response to determining that expected QoS profile adaptation pattern requires QoS profile remapping. Here, said transmission includes a QoS flow indicator and indicates at least one alternative QoS profile.

In some embodiments, the QoS parameters include at least one of the following: a QoS flow ID, a session ID and a UE ID; a prioritized list of QoS profiles, the list including an original QoS profile and at least one alternative QoS profile; a geographical area; a time validity; a hysteresis threshold; and a network slice identifier (i.e., S-NSSAI).

In some embodiments, the first method includes (e.g., after receiving QoS parameters) receiving from the at least one serving RAN node at least one of the following radio parameters: averaged CSI; abstracted CSI measurements; RRM measurements; RLM measurements; RRC parameters for a user; RRC parameters for a cell; RRM function outputs; parameters for a network slice (e.g., slice capacity, slice RRM policies); and UE context parameters (e.g., UE location, UE mobility/velocity).

In certain embodiments, the data analytics model is a trained AI model including at least one of: expected RAN resource conditions (e.g., channel statistics distribution over the entire area with highs and lows) for a future duration (e.g., the next 10 ms to 1 sec—based on the configuration and accuracy of prediction); expected wireless backhaul resource conditions (i.e., channel statistics distribution for the involved backhaul links) for the future duration (i.e., the next 10 ms to 1 sec—based on the configuration and the accuracy of prediction); an expected UE mobility pattern and/or expected UE trajectories for each UE in a service area (e.g., based on the accuracy of prediction); an expected channel quality fluctuation in an expected route of the at least one UE; and expected performance metrics for one or more selected UEs in the service area.

In some embodiments, determining the expected QoS profile adaptation pattern from the data analytics model for the first time interval includes mapping expected conditions to a plurality of QoS profiles, wherein the expected conditions are predicted by the AI model.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for configuring a predictive Quality of Service (“QoS”) adaptation pattern, the method comprising:
receiving a QoS parameter for at least one QoS flow, the at least QoS flow corresponding to at least one user equipment (“UE”);
obtaining a data analytics model, the data analytics model describing at least one expected condition for the at least one UE and/or at least one serving radio access network (“RAN”) node;
determining an expected QoS profile adaptation pattern based on the data analytics model for a first time interval, wherein the expected QoS profile adaptation pattern comprises at least one QoS profile to be associated with the at least one QoS flow during the first time interval; and
transmitting the expected QoS profile adaptation pattern to at least one network node associated with the QoS flow.

2. The method of claim 1, wherein the first time interval comprising a second time interval and a third time interval, wherein the expected QoS profile adaptation pattern comprises a sequence of QoS profiles to be used for the at least one QoS flow, including a first QoS profile for the second time interval and a second QoS profile for the third time interval, the second QoS profile different than the first QoS profile.

3. The method of claim 2, wherein the expected QoS profile adaptation pattern indicates at least one of:
whether a current QoS profile is expected to remain the same for at least one of the first, the second, and the third time intervals and/or for a geographical area;
whether a current QoS profile is expected to downgrade to a different QoS profile for at least one of the first, the second, and the third time intervals and/or for a geographical area; and
whether a current QoS profile is expected to upgrade to a different QoS profile for at least one of the first, the second, and the third time intervals and/or for a geographical area.

4. The method of claim 1, further comprising receiving from the at least one serving RAN node a request to determine the expected QoS profile adaptation pattern, wherein transmitting the expected QoS profile adaptation pattern comprises transmitting to the at least one serving RAN node.

5. The method of claim 1, wherein transmitting the expected QoS profile adaptation pattern comprises sending a predictive QoS report to the at least one serving RAN node, wherein the predictive QoS report includes the expected QoS profile adaptation pattern and at least one of the following:
a QoS flow ID, a session ID, and a UE ID;
a tuning of a hysteresis threshold;
an accuracy of prediction;
an area and time of validity;
an enforcement flag indicating whether the expected QoS profile adaptation pattern is to be enforced;
an upgrade or downgrade indication for each QoS transition in the expected QoS profile adaptation pattern; and
a type of analytics used.

6. The method of claim 5, wherein the RAN node determines whether the expected QoS profile adaptation pattern requires QoS profile remapping or RAN-level adaptation.

7. The method of claim 5, wherein the RAN node transmits to a core network function in response to determining that expected QoS profile adaptation pattern requires QoS profile remapping, wherein said transmission includes a QoS flow indicator and indicates at least one alternative QoS profile.

8. The method of claim 1, wherein the QoS parameter comprises at least one of the following:
a QoS flow ID, a session ID, and a UE ID;
a prioritized list of QoS profiles, the list comprising an original QoS profile and at least one alternative QoS profile;
a geographical area;
a time validity;
a hysteresis threshold; and
a network slice identifier.

9. The method of claim 1, further comprising receiving from the at least one serving RAN node at least one of the following radio parameters:
averaged Channel State Information (“CSI”);
abstracted CSI measurements;
radio resource management (“RRM”) measurements;
radio link monitoring (“RLM”) measurements;
radio resource control (“RRC”) parameters for a user;
RRC parameters for a cell;
RRM function outputs;
parameters for a network slice; and
UE context parameters.

10. The method of claim 1, wherein the data analytics model is a trained artificial intelligence (“AI”) model including at least one of:
expected RAN resource conditions for a future duration;
expected wireless backhaul resource conditions for the future duration;
expected UE mobility pattern and/or UE trajectories for all the UEs in a service area;
expected channel quality fluctuation in an expected route of the UE; and
expected performance metrics for one or more selected UEs in the service area.

11. The method of claim 10, wherein determining the expected QoS profile adaptation pattern from the data analytics model for the first time interval comprises mapping expected conditions to a plurality of QoS profiles, wherein the expected conditions are predicted by the AI model.

12. An apparatus for configuring a predictive QoS adaptation pattern, the apparatus comprising:
an interface that receives a QoS parameter for at least one QoS flow, the at least QoS flow corresponding to at least one user equipment (“UE”); and
a processor that:
obtains a data analytics model, the data analytics model describing at least one expected condition for the at least one UE and/or at least one serving radio access network (“RAN”) node;
determines an expected QoS profile adaptation pattern based on the data analytics model for a first time interval, wherein the expected QoS profile adaptation pattern comprises at least one QoS profile to be associated with the at least one QoS flow during the first time interval; and
transmits the expected QoS profile adaptation pattern to at least one network node associated with the QoS flow.

13. The apparatus of claim 12, wherein the first time interval comprising a second time interval and a third time interval, wherein the expected QoS profile adaptation pattern includes a first QoS profile for the second time interval and a second QoS profile for the third time interval, the second QoS profile different than the first QoS profile.

14. The apparatus of claim 12, wherein the expected QoS profile adaptation pattern indicates at least one of:
whether a current QoS profile is expected to remain the same for at least one of the first, second, and third time intervals and/or for a geographical area;
whether a current QoS profile is expected to downgrade to a different QoS profile for at least one of the first, second, and third time intervals and/or for a geographical area; and
whether a current QoS profile is expected to upgrade to a different QoS profile for at least one of the first, second, and third time intervals and/or for a geographical area.

15. The apparatus of claim 12, wherein the interface receives from the at least one serving RAN node a request to determine the expected QoS profile adaptation pattern, wherein the processor transmits the expected QoS profile adaptation pattern to the at least one serving RAN node.

16. The apparatus of claim 12, wherein transmitting the expected QoS profile adaptation pattern comprises sending a predictive QoS report to the at least one serving RAN node, wherein the predictive QoS report includes the expected QoS profile adaptation pattern and at least one of the following:
a QoS flow ID, a session ID, and a UE ID;
a tuning of a hysteresis threshold;
an accuracy of prediction;
an area and time of validity;
an enforcement flag indicating whether the expected QoS profile adaptation pattern is to be enforced;
an upgrade or downgrade indication for each QoS transition in the expected QoS profile adaptation pattern; and
a type of analytics used.

17. The apparatus of claim 12, wherein the QoS parameters comprise at least one of the following:
a QoS flow ID, a session ID, and a UE ID;
a prioritized list of QoS profiles, the list comprising an original QoS profile and at least one alternative QoS profile;
a geographical area;
a time validity;
a hysteresis threshold; and
a network slice identifier.

18. The apparatus of claim 12, wherein the interface receives from the at least one serving RAN node at least one of the following radio parameters:
averaged Channel State Information (“CSI”);
abstracted CSI measurements;
radio resource management (“RRM”) measurements;
radio link monitoring (“RLM”) measurements;
radio resource control (“RRC”) parameters for a user;
RRC parameters for a cell;
RRM function outputs;
parameters for a network slice; and
UE context parameters.

19. The apparatus of claim 12, wherein the data analytics model is a trained artificial intelligence (“AI”) model including at least one of:
expected RAN resource conditions for a future duration;
expected wireless backhaul resource conditions for the future duration;
expected UE mobility pattern and/or UE trajectories for all the UEs in a service area;
expected channel quality fluctuation in an expected route of the UE; and
expected performance metrics for one or more selected UEs in the service area.

20. The apparatus of claim 19, wherein the processor determines the expected QoS profile adaptation pattern from the data analytics model by mapping expected conditions to a plurality of QoS profiles, wherein the expected conditions are predicted by the AI model.
